(19) United States
(12) Patent Application Publication
(10) Pub. No.: US 2016/0350689 A1
(43) Pub. Date: Dec. 1, 2016

(54) SYSTEM AND METHOD FOR PROVIDING TASK TRACKING

(71) Applicant: NHN Entertainment Corporation, Seongnam-si (KR)

(72) Inventors: Changyol BAEK, Seongnam-si (KR); KyoungHwan LEE, Seongnam-si (KR); Jeong ki KIM, Seongnam-si (KR); YuNi PARK, Seongnam-si (KR); Kunyoung SHIN, Seongnam-si (KR); Dongmin SHIN, Seongnam-si (KR); MinHo CHOI, Seongnam-si (KR); Changwon SON, Seongnam-si (KR); Bu Seung KIM, Seongnam-si (KR); Hyeon Jae PARK, Seongnam-si (KR)

(21) Appl. No.: 15/163,156

(22) Filed: May 24, 2016

(30) Foreign Application Priority Data
May 29, 2015 (KR) 10-2015-0076666
Apr. 14, 2016 (KR) 10-2016-0045479

(51) Int. Cl. G06Q 10/06; G06F 3/0481; G06F 3/0484

(52) U.S. Cl. CPC G06Q 10/06313; G06F 3/04842; G06F 3/0481

(57) ABSTRACT

A task tracking method includes identifying a message that includes project information associated with a project and complete date information of the project or a task associated with the project through a message communication tool; recognizing the identified message as the task to be tracked based on the project information and the complete date information; and tracking the task based on a state of the recognized task, classifying the task, and displaying the task through the message communication tool.

### CROSS-REFERENCE TO RELATED APPLICATION

This application claims priorities from and the benefit of Korean Patent Application Nos. 10-2015-0076666, filed May 29, 2015, and 10-2016-0045479, filed Apr. 14, 2016, which are hereby incorporated by reference for all purposes as if fully set forth herein.

### BACKGROUND

Field

One or more exemplary embodiments relate to technology for performing a collaborative process and, more particularly, to a task tracking method and system.

Discussion of the Background

Business process management relates to separating a business process from an application program, and systematically managing the separated business process. In detail, the business process management performs definition, execution, analysis, and automation of the business process. A business process management system (BPMS) for such business process management may define and model businesses that are repeatedly performed, and may systematically manage and operate relevant documents, information, tasks, etc., with execution of a modeled business.

Recently, as business exchange between companies has become more active, a business process may need to consider a business to be performed in connection with another company as well as in-company activities. Further, there is a need for technology that may connect, and thereby integrally manage, business related processes.

The above information disclosed in this Background section is only for enhancement of understanding of the background of the inventive concept, and, therefore, it may contain information that does not form the prior art that is already known in this country to a person of ordinary skill in the art.

### SUMMARY

One or more exemplary embodiments provide a task tracking method and system that may identify a message that includes project information associated with a project and complete date information of the project or a task associated with the project through a message communication tool, may recognize the message as a task, and may track the task based on a state of the recognized task, classify the task, and display the task through the message communication tool.

Additional aspects will be set forth in the detailed description which follows, and, in part, will be apparent from the disclosure, or may be learned by practice of the inventive concept.

At least one exemplary embodiment provides a task tracking method that includes identifying a message that includes project information associated with a project and complete date information of the project or a task associated with the project through a message communication tool; recognizing the identified message as the task to be tracked based on the project information and the complete date information; and tracking the task based on a state of the recognized task, classifying the task, and displaying the task through the message communication tool.

The identifying of the message may include providing a task layer for inputting the project information and the complete date information, and creating the message in response to an input from a user on at least one of a title, a person in charge, a reference, a description, and a complete date of the project or the task through the task layer.

The identifying of the message may include providing an interface for designating a write form of the task layer and inputting at least one of an equation and an image associated with the project or the task.

The identifying of the message may include providing a template for designating a main text, a reference, a person in charge, a title, and a date associated with the project or the task on the task layer.

The identifying of the message may include switching a text document associated with the project or the task to a specific document by structuring the text document to be in a desired format and by coordinating an arrangement of the text document.

The tracking, the classifying, and the displaying may include indicating that a user is designated as a reference or a person in charge of the task and joins the task in response to a tag being assigned to an input name of the user.

The tracking, the classifying, and the displaying may include indicating a change from a reference to a person in charge or a change from the person in charge to the reference in response to a symbol being assigned to an input name of the person in charge or the reference of the project or the task, and indicating an addition of a new user as the person in charge or the reference of the task in response to another symbol being assigned to an input name of the new user.

The tracking, the classifying, and the displaying may include classifying the task into at least one of an in-progress state, a standby state, and a complete state.

The tracking, the classifying, and the displaying may include classifying the recognized task based on a receiving box that stores a received message as a task, a sending box that stores a sent message as a task, an outbox that stores a temporary message as a task, and a project box.

The tracking, the classifying, and the display may include sorting tasks based on a time at which the message is received, a time at which the project or the recognized task is completed, or a time at which the project or the recognized task is updated.

The tracking, the classifying, and the displaying may include classifying a member using the message communication tool based on a level, and granting a different right to read the task to the classified member.

The tracking, the classifying, and the displaying may include providing an interface for modifying a description of the task to the member granted with the right to read the task.

The tracking, the classifying, and the displaying may include displaying a plurality of members that joins the task in association with the task and displaying a progress state of the task for each of the plurality of members.

The tracking, the classifying, and the displaying may include displaying an importance of the task.

The tracking, the classifying, and the displaying may include displaying a task description corresponding to a selected task in response to a selection on at least one task from among tasks displayed through the message communication tool, and the task description corresponding to the selected task may include a sender, a participant, a main text, an attachment file, a work log and/a lower work of the selected task.

The tracking, the classifying, and the displaying may include displaying a lower task associated with the task with respect to the task.

The tracking, the classifying, and the displaying may include, in response to a specific task moved from a different project, automatically numbering the moved specific task using a number associated with the different project and maintaining a link to the project or the different project at the specific task.

The tracking, the classifying, and the displaying may include providing a search box for inputting a keyword associated with the task and displaying a search result associated with the keyword in response to an input of the keyword into the search box.

At least one exemplary embodiment also provides a non-transitory computer-readable medium storing computer-readable instructions to cause a computer system to perform a task tracking method including identifying a message that includes project information associated with a project and complete date information of the project or a task associated with the project through a message communication tool; recognizing the identified message as the task based on the project information and the complete date information; and tracking the task based on a state of the recognized task, classifying the task, and displaying the task through the message communication tool.

At least one exemplary embodiment also provides a task tracking system including a display, and a processor configured with executable instructions to provide an identifier and a recognizer and drive the display. The identifier is configured to identify a message that includes project information associated with a project and complete date information of the project or a task associated with the project through a message communication tool. The recognizer is configured to recognize the identified message as the task based on the project information and the complete date information. The display is configured to track the task based on a state of the recognized task, classifying the task, and to display the task through the message communication tool.

A task tracking system according to at least some exemplary embodiments may provide an integrally available message communication tool by recognizing, as a task, a message that includes project information associated with a project and complete date information of the project or a task associated with the project, an e-mail, a messenger, a task tracker, a document, etc., and by enabling interoperation thereof.

A task tracking system according to at least some exemplary embodiment enables a collaboration between members that join each task through a message communication tool and also enables a progress state of the task to be shared in real time.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating a user terminal and a server according to at least one exemplary embodiment;

FIG. 2 is a block diagram illustrating a configuration of a task tracking system according to at least one exemplary embodiment;

FIG. 3 is a flowchart illustrating a task tracking method performed at a task tracking system according to at least one exemplary embodiment;

FIG. 4 and FIG. 5 illustrate examples of operating a message communication tool of a task tracking system according to at least one exemplary embodiment;

FIG. 6, FIG. 7, and FIG. 8 illustrate examples of sorting tasks at a task tracking system according to at least one exemplary embodiment;

FIG. 9 and FIG. 10 illustrate examples of explaining a description of a task at a task tracking system according to at least one exemplary embodiment;

FIG. 11 illustrates an example of providing task layer at a task tracking system and creating a project or a task associated with the project according to at least one exemplary embodiment;

FIG. 12 illustrates an example of conducting a search using a search box at a task tracking system according to at least one exemplary embodiment; and

FIG. 13, FIG. 14, and FIG. 15 illustrate examples of setting account information at a task tracking system according to at least one exemplary embodiment.

It should be noted that these figures are intended to illustrate the general characteristics of methods and/or structure utilized in certain exemplary embodiments and to supplement the written description provided below. These drawings are not, however, to scale and may not precisely reflect the precise structural or performance characteristics of any given embodiment, and should not be interpreted as defining or limiting the range of values or properties encompassed by exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another, element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Exemplary embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more exemplary embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data tiles, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the compute processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more exemplary embodiments, computer processing devices may be described as including various functional units that perform various operations and/or functions to increase the clarity of the description. However, computer processing devices are not intended to be limited to these functional units. For example, in one or more exemplary embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more exemplary embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the exemplary embodiments described herein. The computer programs, program code, instructions, or some combination thereof, may also be loaded from a separate computer readable storage medium into the one or more storage devices and/or one or more computer processing devices using a drive mechanism. Such separate computer readable storeage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the exemplary embodiments, or they may be known devices that are altered and/or modified for the purposes of exemplary embodiments.

A hardware device, such as a computer processing device, may run an operating system (OS) and one or more software applications that run on the OS. The computer processing device also may access, store, manipulate, process, and create data in response to execution of the software. For simplicity, one or more exemplary embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions, and substitutions of exemplary embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Exemplary embodiments relate to technology for recommending a meeting place using appointment information. In detail, the exemplary embodiments relate to a method, system, and non-transitory computer-readable medium that may provide appointment information of a meeting users are to attend to affiliated stores, may receive a recommendation on a meeting place from the affiliated stores, and may provide the received recommendation information to the users.

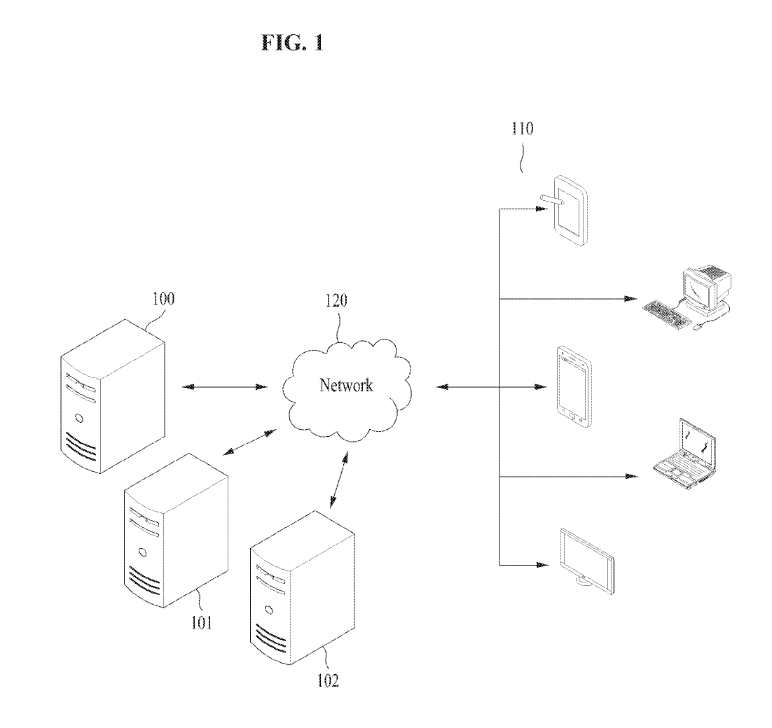

FIG. 1 is a diagram illustrating an example of a network environment that includes a user terminal 110, a plurality of servers 100, 101, and 102, and a network 120. FIG. 1 is provided as an example only and the number of user terminals and/or the number of servers are not limited thereto.

The user terminal 110 may be a fixed terminal or a mobile terminal configured as a computer device. For example, the user terminal 110 may be a smartphone, a mobile phone, a navigation device, a desktop computer, a laptop computer, a digital broadcasting terminal, a personal digital assistant (PDA), a portable multimedia player (PMP), a tablet PC, and the like. For example, the user terminal 110 may communicate with other user terminals and/or the servers 100, 101, and 102 over the network 120 in a wired communication manner or in a wireless communication manner.

The communication scheme is no particularly limited and may include a communication scheme that uses near field communication between devices as well as a communication method using a communication network, for example, a mobile communication network, the wired Internet, the wireless Internet, and a broadcasting network. For example, the network 120 may include at least one of various networks selected from, for example, a personal area network (PAN), a local area network (PLAN), a campus area network (CAN), a metropolitan area network (MAN), a wide area network (WAN), a broadband network (BBN), the Internet, and the like. Also, the network 120 may include at least one of network topologies that include a bus network, a star network, a ring network, a mesh network, a star-bus network, a tree or hierarchical network, and the like. However, these are only examples and the exemplary embodiments are not limited thereto.

Each of the servers 100, 101, and 102 may be configured as a computer apparatus or a plurality of computer apparatuses that provides instructions, codes, files, contents, services, and the like, through communication with the user terminal 110 over the network 120.

For example, the server 100 may provide a file for installing an application to the user terminal 110 connected over the network 120. In this case, the user terminal 110 may install the application using the file provided from the server 100. The user terminal 110 may use a service and/or content provided from the server 100 by connecting to the server 100 under control of an operating system (OS) included in the user terminal 110 and at least one program, for example, a browser or the installed application. For example, in response to a service request message transmitted from the user terminal 110 to the server 100 over the network 120 under control of the application, the server 100 may transmit a code corresponding to the service request message to the user terminal 110. The user terminal 110 may provide content to a user by displaying a code-based screen under control of the application.

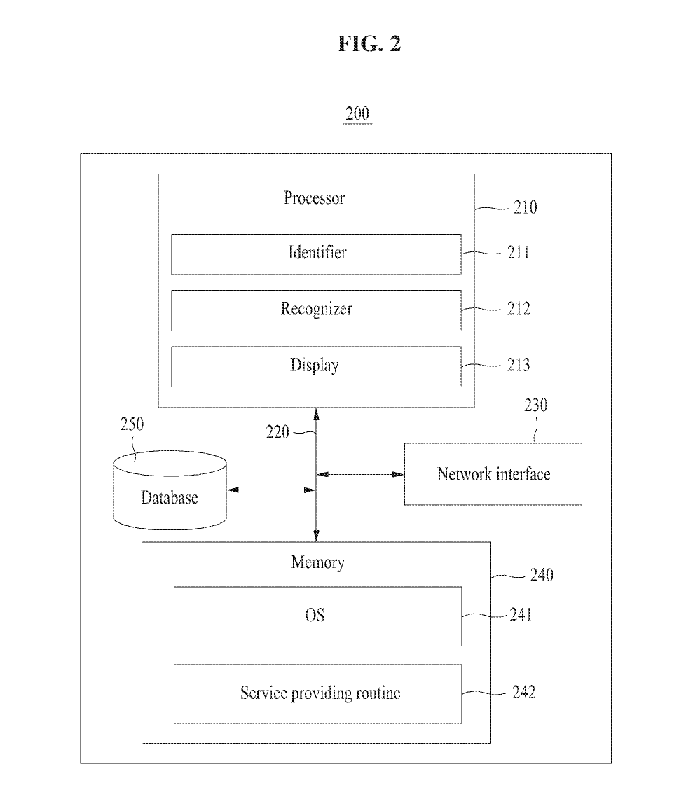

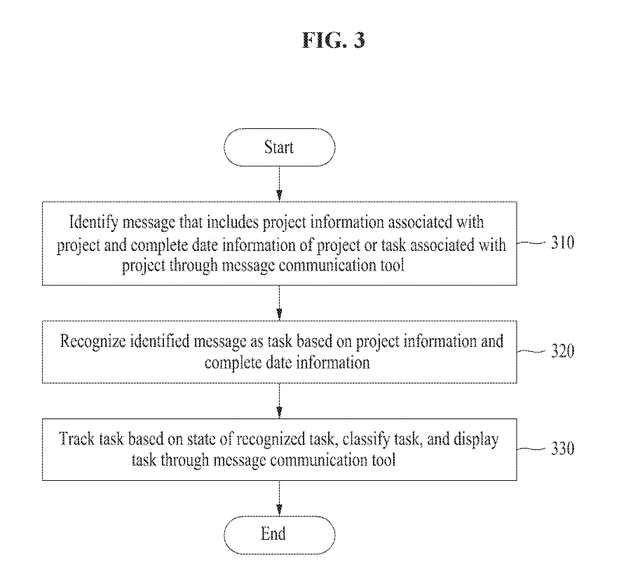

FIG. 2 is a block diagram illustrating a configuration of a task tracking system according to at least one exemplary embodiment.

Referring to FIG. 2, a task tracking system 200 may include a processor 210, a bus 220, a network interface 230, a memory 240, and a database 250. The memory 240 may include an OS 241 and a service providing routine 242. The processor 10 may include an identifier 211, a recognizer 212, and a display 213 associated with the processor 210. According to other exemplary embodiments, the task tracking system 200 may include a greater or lesser number of constituent elements than the number of constituent elements shown in FIG. 2. However, there is no need to clearly illustrate many constituent elements according to the related art. For example, the task tracking system 200 may include other constituent elements such as a transceiver (not shown).

The memory 240 may include a permanent mass storage device, such as random access memory (RAM), read only memory (ROM), a disc drive, a solid state drive, an optical drive, etc., as a computer-readable storage medium. Also, program codes (e.g., computer readable instructions) for the OS 241 and the search result providing routine 242 may be stored in the memory 240. Such software constituent elements may be loaded from another computer-readable storage medium separate from the memory 240 using a drive mechanism (not shown). The other computer-readable storage medium may include, for example, a floppy drive, a disc, a tape, a DVD/CD-ROM drive, a memory card, flash memory, etc. Software constituent elements may be loaded to the memory 240 through the network interface 230 instead of, or in addition to, the computer-readable storage medium.

The bus 220 enables communication and data transmission between the constituent elements of the task tracking system 200. The bus 220 may be configured using a high-speed serial bus, a parallel bus, a storage area network (SAN), and/or another appropriate communication technology.

The network interface 230 may be a computer hardware constituent element for connecting the task tracking system 200 to the computer network. The network interface 230 may be a network interface card, such as an Ethernet card, an optical transceiver, a radio frequency transceiver, or a different type of a device capable of transmitting and receiving information. Other examples of network interfaces may be mobile computing devices and wireless devices that include Blu-tooth, USB, 3G, WiFi, etc. In some examples, a computing device may use the network interface 230 to wirelessly communicate with an external device, such as a server, a mobile phone, an external device such as another networking computing device, etc. The network interface 230 may connect the task tracking system 200 to the computer network through a wireless and/or wired connection.

The database 250 may serve to store and manage information required to manage information about a project or a task associated with the project, and the like. Although FIG. 2 illustrates that the database 250 is included in the task tracking system 200, it is an example. Based on a system configuration method, an environment, and the like, the database 250 may be omitted. Alternatively, the entire or a portion of the database 250 may be present as an external database constructed on a separate system.

The processor 210 and constituent elements of the processor 210 may be configured to execute computer-readable instructions according to at least one program code and a code of the OS 241 included in the memory 240. The computer-readable instructions may be provided from the memory 240 and/or the network interface 230 to the processor 210 through the bus 220. The processor 210 may be configured to execute program codes for the identifier 211, the recognizer 212, and operation/driving of the display 213. The program codes may be stored in a storage device such as the memory 240.

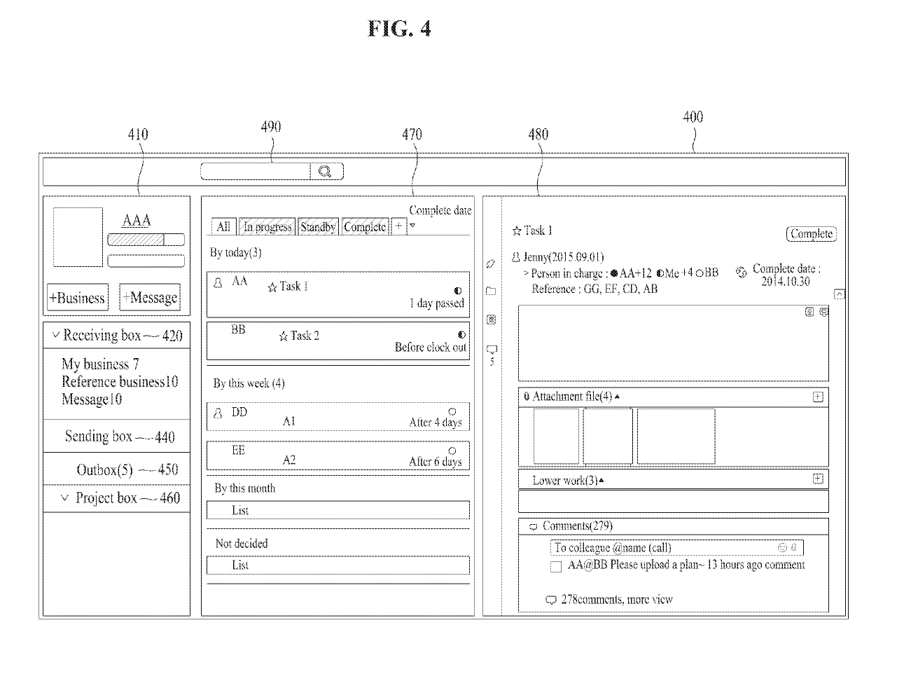

The constituent elements of the processor 210 and the task tracking system 200 may control the task tracking system 200 to perform operations 310 through 330 included in the task tracking method of FIG. 3. The processor 210 may load a program code for the task tracking method to the memory 240.

In operation 310, the identifier 211 may identify a message that includes project information associated with a project and complete date information of the project or a task associated with the project through a message communication tool. The identifier 211 may provide a task layer for inputting the project information and the complete date information and may create the message in response to an input from a user on at least one of a title, a person in charge, a reference, a description, and a complete date of the project or the task through the task layer. The identifier 211 may provide an interface for designating a write form of the task layer and inputting at least one of an equation and an image associated with the project or the task. The identifier 211 may provide a template for designating a main text, a reference, a person in charge, a title, and a date associated with the project or the task on the task layer. The identifier 211 may switch a text document associated with the project or the task to a specific document by structuring the text document to be in a preset (or, alternatively, desired) format and by coordinating an arrangement of the text document.

In operation 320, the recognizer 212 may recognize the identified message as the task based on the project information and the complete date information,

In operation 330, the display 213 may be used to track the task based on a state of the recognized task, may classify the task, and may display the task through the message communication tool. The display 213 may classify the task into one of an in-progress state, a standby state, and a complete state. The display 213 may classify the recognized task based on a receiving box that stores a received message as a task, a sending box that stores a sent message as a task, an outbox that stores a temporary message as a task, and a project box. The display 213 may sort tasks based on a time at which the message is received, a time at which the project or the recognized task is completed, or a time at which the project or the recognized task is updated. The display 213 may display an importance of the task.

The display 213 may display a task description corresponding to a selected task in response to a selection on at least one task from among tasks displayed through the message communication tool. The display 213 may display a lower task associated with the task with respect to the task. In response to a specific task moving from another project, the display 213 may automatically number the moved specific task using a number associated with the other project and may maintain a link to the project or the other project at the specific task.

If a tag is assigned to an input name of the user, the display 213 may indicate that the user is designated as a reference or a person in charge of the task and joins the task. If a symbol is assigned to an input name of the person in charge or the reference of the project or the task, the display 213 may indicate a change from the reference to the person in charge or a change from the person in charge to the reference. Also, if another symbol is assigned to an input name of a new user, the display 213 may indicate an addition of the new user as the person in charge or the reference of the task.

The display 213 may display plurality of members that have joined the task in association with the task and may display a progress state of the task for each of the plurality of members. The display 213 may classify a member using the message communication tool based on a level, and may assign a different right to read the task to the classified member. The display 213 may provide an interface for modifying a description of the task to the member granted with the right to read the task.

The display 213 may provide a search box for inputting a keyword associated with the task and may display a search result associated with the keyword in response to an input of the keyword into the search box.

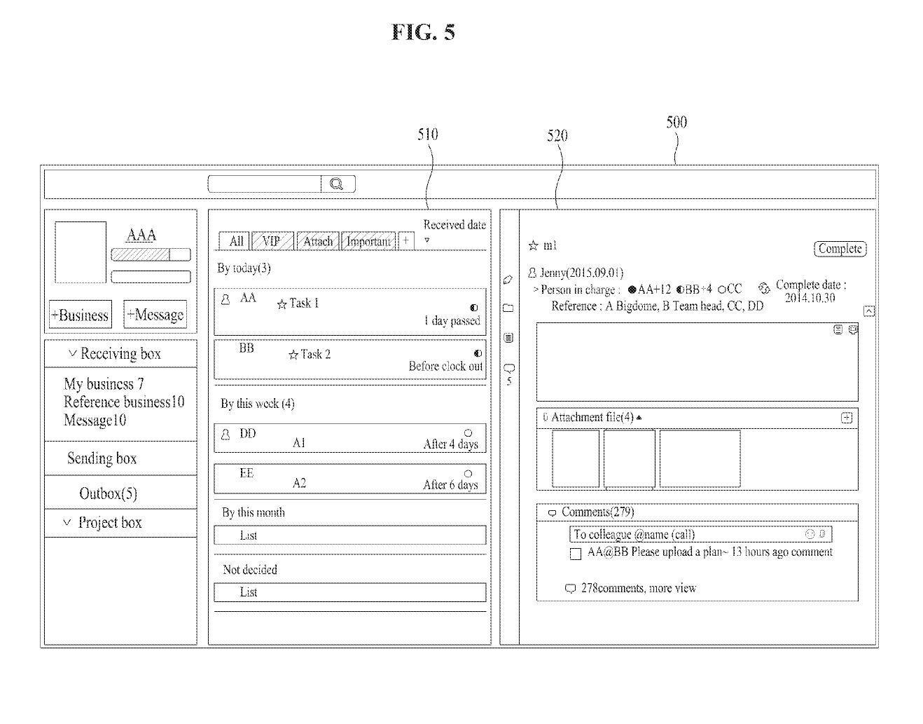

FIGS. 4 and 5 illustrate examples of operating a message communication tool of a task tracking system according to at least one exemplary embodiment.

The task tracking system may recognize messages as tasks and may display the recognized messages through a message communication tool 400, 500. The message communication tool 400, 500 may display a project and a task associated with the task. Here, a message, an e-mail, a task tracker, a messenger, a document file, etc., associated with the project may be recognized as the task. The task tracking system may provide a user interface for controlling the project and the task associated with the project through the message communication tool 400, 500.

The task tracking system may assign an account to each user, and may provide the message communication tool 400, 500 so that each user may use the message communication tool 400, 500 by connecting to the message communication tool 400, 500. For example, to use the message communication tool 400, 500, the user may connect to the message communication tool 400, 500 by inputting an identifier (ID) and a password.

The task tracking system may recognize a message as a task, may track and classify the task based on a state of the recognized task, and may display the classified task through the message communication tool 400, 500.

The message communication tool 400 may include an account area 410, storing boxes, for example, a receiving box 420, a sending box 440, an outbox 450, and a project box 460, a list area 470 for displaying a list of tasks, and a main text area 480 for displaying a selected task. The message communication tool 500 may include a list area 510 and a text area 520. The message communication tool 400 may provide a search box 490 for searching for information about a project and a task associated with the project.

The message communication tool 400 may include the receiving box 420 that stores a received message as a task, the sending box 440 that stores a sent message as a task, the outbox 450 that stores a temporary message as a task, and the project box 460, as the storing boxes. Here, the task tracking system may create a detailed folder in each of the storing boxes based on a preset criterion or a user setting. For example, the receiving box 420 may include a detailed folder about a user's business (“My business”), a reference business, and a message in association with the project or the task. Each project or task may be automatically classified and stored in the detailed folder. In response to a user selection on their business of the receiving box 420 through the message communication tool 400, a project or a task associated with the selected my business may be displayed on the list area 470.

The task tracking system may sort and display a project associated with an account and tasks associated with the project on the list area 470, 510 of the message communication tool 400, 500. The task displayed on the list area 470, 510 may be displayed together with a sender, a title of the task, state information, importance, a person in charge of the task, a reference, etc.

The task tracking system may classify a task into at least one of an in-progress state, a standby state, and a complete state and may display the classified task on the list area 470, 510 of the message communication tool 400, 500. Also, with respect to each of a plurality of tasks displayed on the list area 470, 510 of the message communication tool 400, 500, the task tracking system may display a plurality of members that joins the task and may display a progress state of the task for each of the plurality of members. For example, the task tracking system may different display a progress state of each of the plurality of members that joins the task.

Also, the task tracking system may classify a member based on a preset level. For example, the task tracking system may classify a member into a guest or a general user. The task tracking system may be set such that a member classified as a guest may not read a task displayed on the list area 470, 510, and may read only a task associated with a project joined by the member classified as the guest. Here, the task tracking system may provide an interface for modifying a description of the task to the member granted with the right to read the task. Alternatively, the task tracking system may grant the member with the right to read only a portion of the plurality of tasks and may allow the member to modify the task allowed to be read.

In response to a selection on at least one of the projects or the tasks displayed on the list area 470, 510 of the message communication tool 400, 500, the task tracking system may display a description of the task on the main text area 480, 520 for displaying a task. Here, the task tracking system may assign a right to read a description of the project. For example, the task tracking system may assign a right to read a project and a task associated with the project only to an invitee of the project. Alternatively, the task tracking system may set a project and tracking of the project so that tracking by the entire employees or only by a member himself or herself may be read. If a project is created and only a member is designated, the project may be used to manage a business of the member.

Alternatively, the task tracking system may grant a right to read a description of a project and a task associated with the project through combination. For example, the task tracking system may set a right so that only a team and a writer associated with a specific project may read the specific project in response to a request for the specific project and may grant the set right to the team and the writer. In this example, the task tracking system may recognize a person allowed to read the task as a person associated with the project and may grant a right to modify a description of the task to the recognized person.

Referring to FIG. 4, account information associated with an account connected by connecting to an account of each user may be displayed on the account area 410. The account area 410 may be an area for displaying a name of a user corresponding to the account, state information of the user, information associated with a project and a task, etc. For example, the task tracking system may provide an interface for supporting a profile setting, an absence setting, a logout, etc., on the account area 410 through the message communication tool 400.

The task tracking system may provide an interface for creating a message through a task layer for inputting project information associated with the project and complete date information of the project or the task associated with the project. For example, the task tracking system may provide a business interface for inputting project information associated with the project and a message interface for inputting information of the task associated with the project on the account area 410. In response to a selection on the business interface or the message interface, a task layer may be provided.

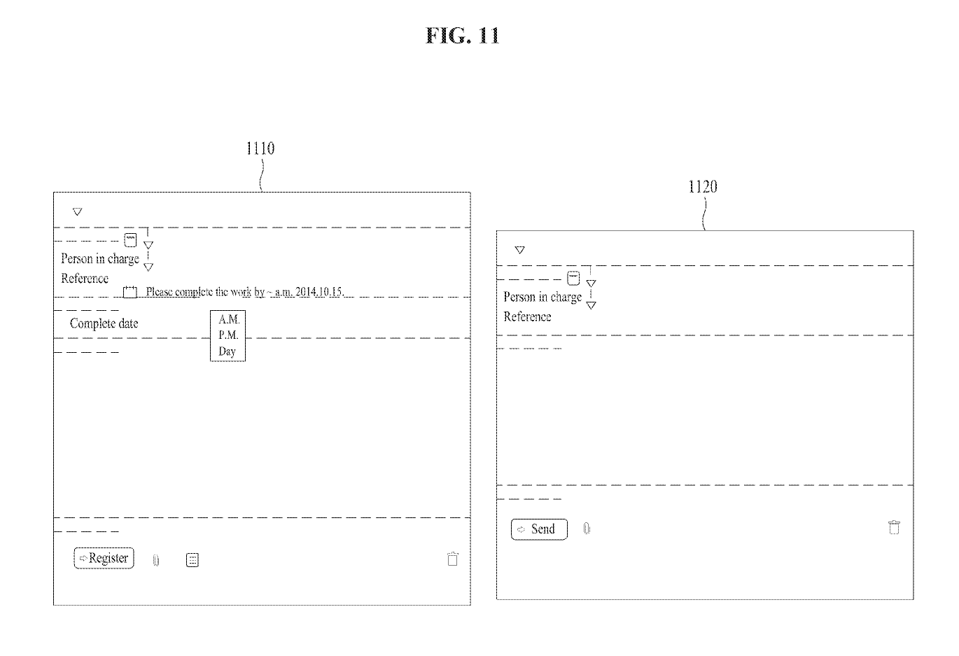

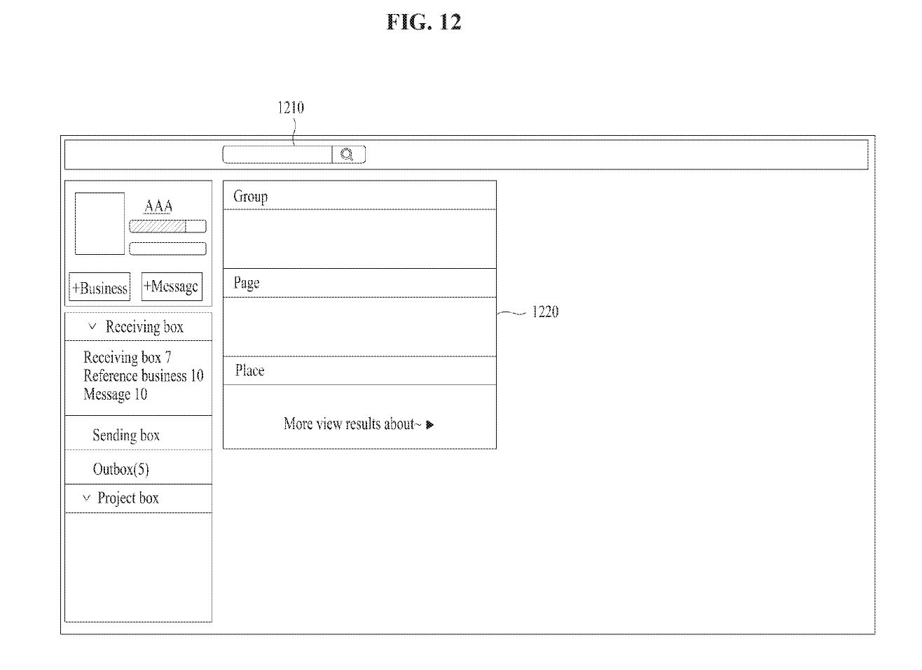

FIG. 11 illustrates an example of a task layer 1110, 1120 to describe a method of creating a project or a task associated with the project by providing the task layer 1110, 1120 at the task tracking system. Without being limited to the example of FIG. 11, the task layer 1110, 1120 may be provided in various types. For example, the task layers 1110 and 1120 may include a business layer for inputting project information associated with a project and a message layer for inputting task information of a task associated with the project.

The task tracking system may provide a template for designating a main text, a reference, a person in charge, a title, and a date associated with the project or the task on the task layer 1110 1120. In detail, the task tracking system may provide an interface configured to designate a write form of the task layer 1110, 1120 by applying an open source to the task layer 1110, 1120, and to input at least one of an equation and image associated with the project or the task. In this example, the task tracking system may insert a check box into an input area for inputting a description on the task layer 1110, 1120, so that the user may conveniently input a desired description through the check box.

The user may designate a template through the task layer 1110, 1120. For example, the user may designate a template with respect to a portion frequently used in the task layer 1110 1120. Here, the task tracking system may allow a present date to b automatically designated in response to an input from a user on a preset symbol, instead of directly inputting the present date. For example, if the user inputs ‘[$]’ on the task layer 1110, 1120, the present date may be automatically displayed.

The task tracking system may create a project or a task in response to an input of at least one of a main text, a reference, a person in charge, a title, and a date associated with the project or the task. Here, the task tracking system may provide an interface for allocating a plurality of references and persons in charge to the project or the task. For example, the task tracking system may provide the respective interfaces, for example, input boxes, for inputting a title of the project, a person in charge, a reference, a due date, a complete date, of the project, and a description of the main text on the task layer 1110 corresponding to a business layer. Similarly, the task tracking system may provide an interface, for example, an input box, for inputting information associated with the task, on the task layer 1120 corresponding to a message layer. The user may create a message, an e-mail, a document, etc., associated with the project through the message layer. The task tracking system may provide an interface for using a file attachment function, a lower work creation function, a delete function, etc., on the task layer 1110, 1120.

Additionally, the task tracking system may switch a text document associated with the project or the task to a specific document by structuring the text document to be in a desired format and by coordinating an arrangement of the text document. For example, the task tracking system may provide a function of switching an e-mail configured as a text document to publication data, conference data, etc. The task tracking system may structure a document and may coordinate a text arrangement to be suitable for a format of a specific document.

The task tracking system may automatically apply a schedule of the project or the task to a calendar in response to an acceptance of the schedule. Further, the task tracking system may maintain schedule information associated with the project or the task.

As described above, the task tracking system may recognize, as a task, a message that includes project information and task information associated with the project based on information input from the user through the respective interfaces, may track the recognized task, and may register and display the tracked task using a message communication tool.

Here, a project or a task written by the user may be displayed on the message communication tool. Also, a project or a task transmitted from another user aside from the user may be received and displayed on the message communication tool. Hereinafter, an operation method of the message communication tool on the side of a second user will be described. A first user may transmit, to the second user, a message that includes a project or a task associated with the project through a task layer on the message communication tool. The task tracking system may receive the message transmitted from the first user. The task tracking system may determine that the message transmitted from the first user is a project or a task associated with the project the second user proceeds with. Based on the determination, the task tracking system may recognize the message transmitted from the first user as the task, may track and classify the task based on a state of the recognized task, and may display the classified task on the message communication tool. Also, a message that includes project information and complete date information of the task associated with the project, which are created by the second user through the task layer on the message communication tool, may be recognized as the task and may be stored in and displayed on the message communication tool of the second user.

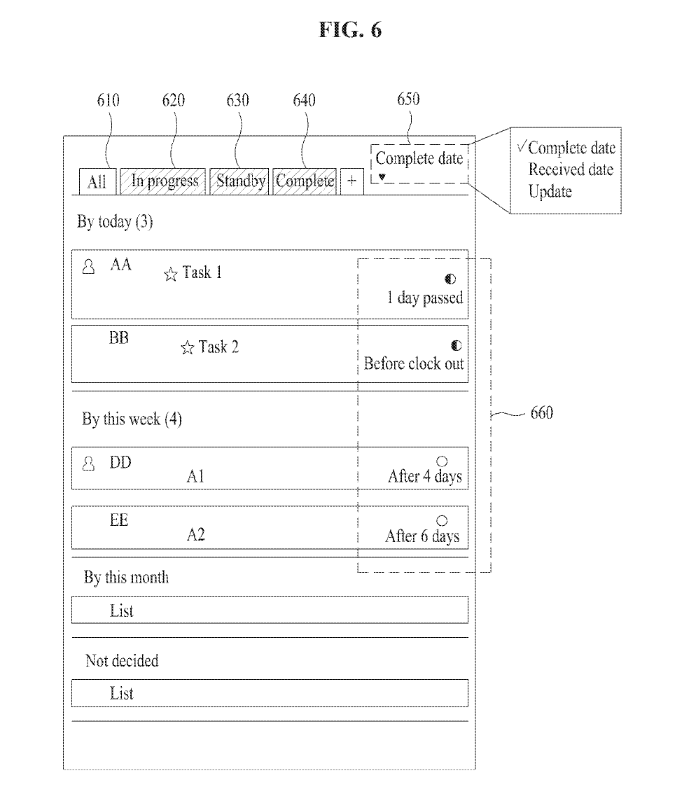

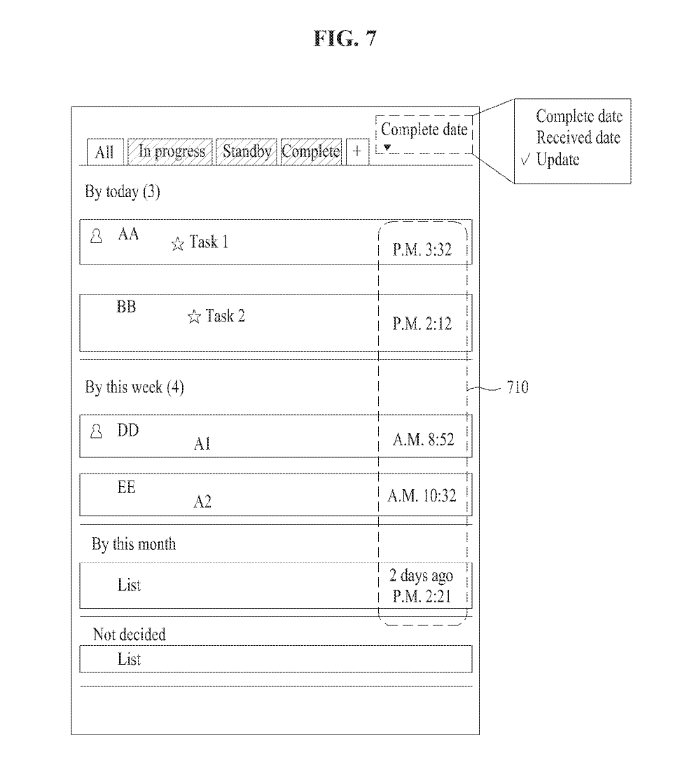

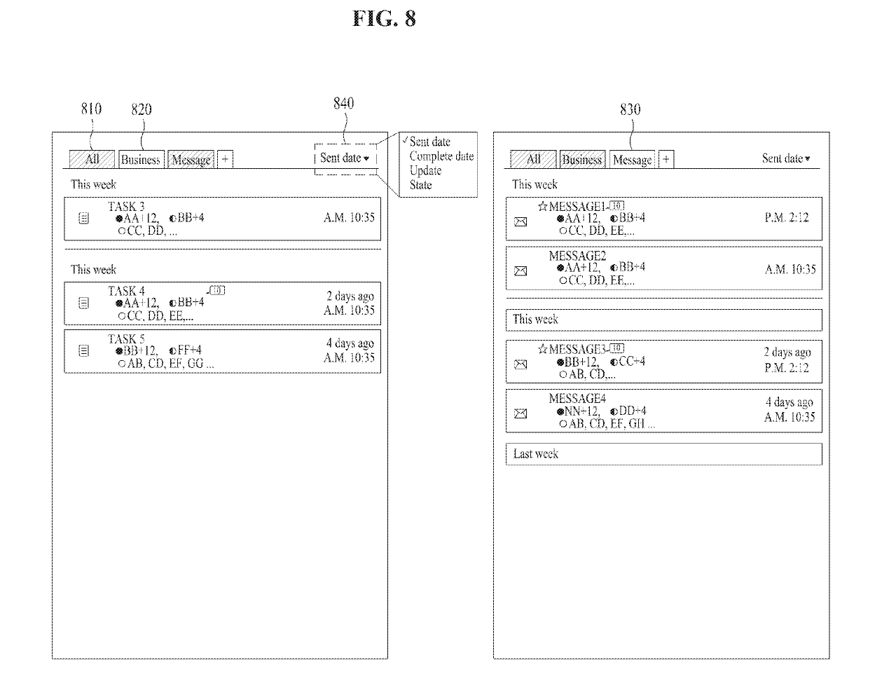

FIGS. 6 through 8 illustrate examples of sorting tasks at a task tracking system according to at least one exemplary embodiment.

In response to a selection on a storing box, the task tracking system may display a project and tasks associated with the project, stored in the selected storing box, on a list area, for example, the list area 470, 510, of a message communication tool. The task tracking system may classify and display each task on the list area of the message communication tool based on a progress state of the task. The task tracking system may provide an interface 650 for sorting tasks stored in the list area of the message communication tool based on a received date, a complete date, or an update date. The task tracking system may sort and display tasks based on a received date, a complete date, or an update date of a task. For example, referring to box 660 of FIG. 6 indicated with dotted lines, the task tracking system may sort tasks stored in a receiving box from close to far based on the complete date on the list area. Referring to box 710 of FIG. 7 indicated with dotted lines, the task tracking system may display a list of tasks from latest to oldest based on the update date on the list area. In this example, the task tracking system may also display a state of a person in charge or a reference that joins a project in association with each task displayed on the list area. The state of the person in charge or the reference may indicate a task progress state of the person in charge or the reference about the project or the task associated with the project.

The task tracking system may separately classify and display an in-progress list, a standby list, and a complete list with respect to tasks. The task tracking system may provide the respective interfaces 610, 620, 630, and 640 for sorting and thereby displaying all tasks, a task in progress, a task in standby, and a complete task on the list area. In response to a selection on at least one of the interfaces 610, 620, 630, and 640, the task tracking system may display a list of tasks corresponding to the selected interface.

Referring to FIG. 8, the task tracking system may display a list of tasks stored in a sending box on a list area. The task tracking system may provide an interface 840 for sorting tasks displayed on a list area of a message communication tool based on a sent date, a complete date, or an update date of a task, or a progress state of a project. The task tracking system may sort and display tasks based on the sent date, the complete date, or the update date. Here, the task tracking system may display a state of a person in charge or a reference that joins the project in association with each task displayed on the list area. The state of the person in charge or the reference may indicate a task progress state of the person in charge or the reference with respect to the project or the task associated with the project. For example, the person in charge or the reference may classify and thereby display members based on a complete state, an in-progress state, a pre-start state, and may classify the members into a complete member, a member in progress, and a pre-start member, and may display the classified members.

The task tracking system may determine a progress state of a project or a task associated with the project with respect to members. The task tracking system may provide an interface for designating a plurality of persons in charge with respect to a specific project or a task associated with the specific project through a task layer. The task tracking system may indicate an importance of a task. The task tracking system may determine a progress state of a project or a task of a member by marking each member in a different color based on a progress state of the project or the task with respect to the plurality of persons in charge. For example, assume that a project title is “file a patent”. A person in charge of the project may be indicated with AAA (in progress), BBB (complete), or CCC (before start). The task tracking system may determine a progress state of each member with respect to a project or a task associated with the project through a list of members stored in a sending box. For example, the task tracking system may display the progress state in association with a complete date, a main person in charge, etc., of the project or the task. The task tracking system enables a member that does not join the project or the task to verify a progress state of another member, thereby comparing a progress state of the member to the progress state of the other member.

The task tracking system may provide the respective interfaces, for example, the interfaces 810 and 820, for sorting and thereby displaying all tasks, a task in progress, a task in standby, and a complete task on a list area. In response to a selection on at least one of the interfaces, the task tracking system may display a list of tasks corresponding to the selected interface. Also, the task tracking system may display an importance, a code name/business number, a title, a complete date, a lower work, etc., with respect to tasks displayed on the list area.

Also, the task tracking system may display a list of tasks stored in an outbox on the list area. The task tracking system may classify and thereby display tasks displayed on the list area into a temporary storing project, a message list, etc. Here, the task tracking system sort tasks displayed on the list area from latest to oldest. If an input description is present, the task tracking system may also display the description. If a task has no title, the task tracking system may indicate “no title”.

Also, the task tracking system may display a list of tasks stored in a project box on the list area. With respect to tasks displayed on the list area, the task tracking system may provide interfaces, for example, an interface 830, for classifying and thereby displaying all lists associated with a project, a project list, an e-mail list, a message list, etc. In response to a selection on at least one of the interfaces, the task tracking system a display a list of tasks corresponding to the selected interface. The task tracking system may classify and thereby display al lists associated with a project, a project list, an e-mail list, a message list, etc., on the list area. Here, all lists may be sorted based on a registration date or an update date associated with a project. The project list may be sorted based on a registration date, a complete date, an update date, or state information. The message list may be sorted based on a registration date or an update date. Here, the task tracking system may apply and display a state of a person in charge or a reference that joins a project in association with each task displayed on the list area. The state of the person in charge or the reference may indicate a task progress state of the person in charge or the reference with respect to the project or the task associated with the project. For example, the person in charge or the reference may classify and thereby display members based on a complete state, an in-progress state, a pre-start state, and may classify the members into a complete member, an in-progress member, and a pre-start member, and may display the classified members for each group. Also, the task tracking system may display a sender, a state of a person in charge and a reference, an importance, a code name/business number, a title, and a lower work on the list area.

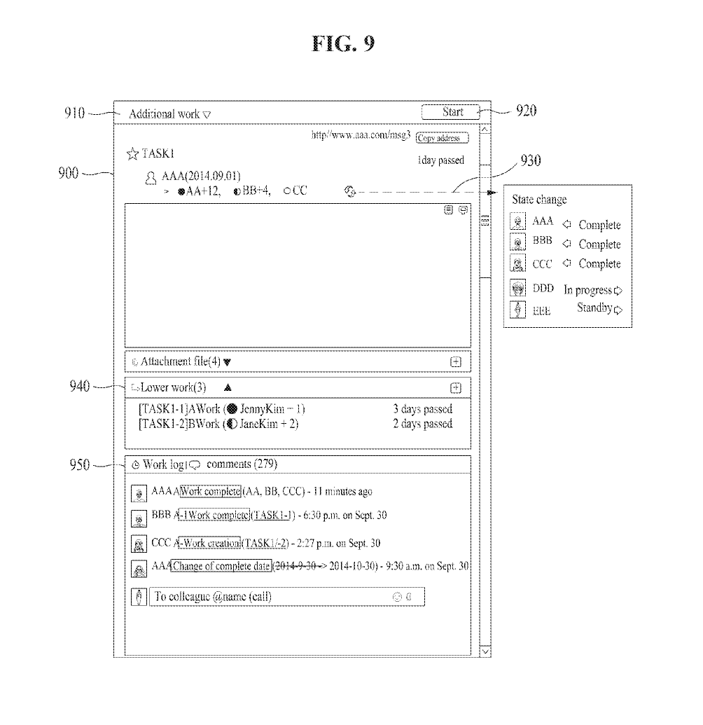

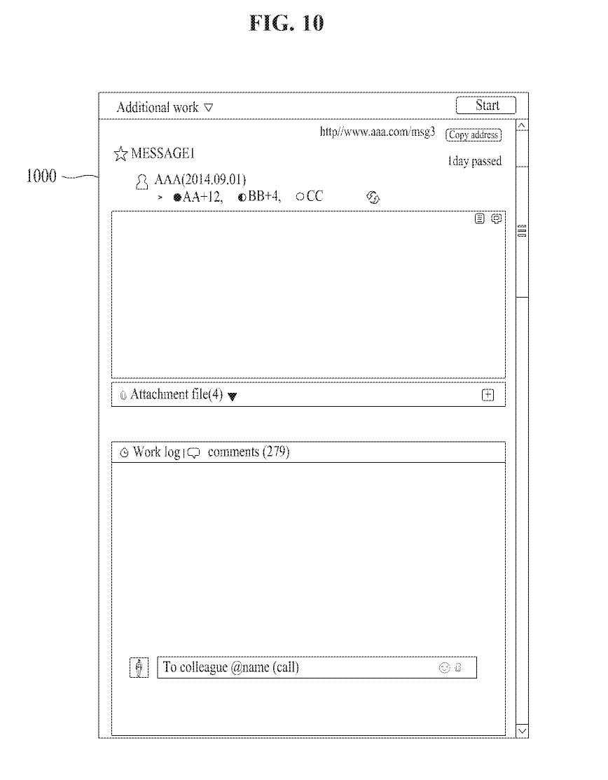

FIGS. 9 and 10 illustrate examples of explaining a description of a task at a task tracking system according to at least one exemplary embodiment.

The task tracking system may display, on a main text area, a description of a task selected from among tasks displayed on a list area of a message communication tool. The task tracking system may include project information or task information in a description 900, 1000 of a project or a task.

FIGS. 9 and 10 illustrate the description 900, 1000 of a project or a task associated with the project. The task tracking system may provide an interface for implementing an additional work 910 on the description 900 of the project or the task associated with the project, a sender area for indicating a sender, a person-in-charge area for indicating a person in charge, a description area for indicating a description, an edit interface, an attachment file area for attaching a file, a lower work area 940 for creating a lower work associated with the project or the task, and a work log area 950 for recording a content associated with the project or the task.

The description 900 of the project or the task associated with the project may include at least one of the additional work 910, the sender, the person in charge, the reference, the description, the attachment file, the lower work, and the work log. Also, the description 900, 1000 may include a title of the project, a code name and a business number of the project, an importance of the project, etc. Also, the description 900, 1000 may provide an interface for displaying a complete date and changing the complete date. Also, the description 900, 1000 may include state information of the sender, the person in charge, and the reference. The sender, the person in charge, and the reference may change project state information of a member through an interface 930 for changing a state of the sender, the person in charge, and the reference, respectively. For example, the task tracking system may distinguishably display the sender, the person in charge, and the reference using different colors, and may also highlight and thereby display the sender, the person in charge, and/or the reference to be distinguished from others. Also, the task tracking system may classify a member that joins the task into a reference or a person in charge based on a participation level for the project or the task associated with the project, and may classify a member designated as the person in charge into a reception task and may classify a member designated as the reference into a reference task. Since each member is classified into the reference or the person in charge, the task tracking system may provide a different publication range for each task.

The task tracking system may display a unique link, for example, a uniform resource locator (URL) of the project or the task associated with the task on the description 900, 1000, and may provide an interface for duplicating an address of the link. Here, when the person in charge or the reference joining the project or the task moves from the project or the task to another task, the task tracking system may automatically number the moved project or task using a number associated with the other project and may maintain the link to the moved project or task.

The task tracking system may provide an interface for uploading an attachment file to the description 900, 1000 of the project or the task, and may also provide a function, such as an attachment file name, an extender, a capacity, a store, a preview, etc.

The task tracking system may display a lower work associated with the project on the lower work area 940 included in the description 900, 1000 of the project or the task. For example, if members associated with the project prepare lower works associated with the project, lower tasks associated with the project may be displayed on the lower work area 940. For example, a project code name, a business number, a title, a state of business, etc., of a lower work associated with the project may be displayed.

The task tracking system may record a log of the project or the task on the work log area 950 included in the description 900, 1000 of the project or the task. For example, since members that join the project may post comments, a progress state of the task, a modification of the task, etc., may be shared A profile, a work description, work information, a work time, a work comment, etc., of a member may be displayed as a comment on the work log area 950. Here, the task tracking system may assign a tag to a member who does not join the task associated with the project, may designate the member as a person in charge or a reference of the task, and thereby enable the member to join the task. The task tracking system may assign a tag to a user on the work log area 950 and may call the user as a reference or a person in charge of the task. For example, the task tracking system may assign a preset tag to a name of a user on the work log area 950, so that the user assigned with the tag may be designated as a reference or a person in charge of a task and may join the task. For example, if a user puts ‘@+name’ on the work log area 950, a user corresponding to the name added to @ may be designated as a reference or a person in charge of a task. Also, if a preset symbol is assigned to an input name of a person in charge or a reference of a project or a task, the task tracking system may indicate a change from the reference to the person in charge or a change from the person in charge to the reference. For example, if the user inputs ‘->+name’ on the work log area 950, a user corresponding to the name added to ‘->’ may be changed from a person in charge to a reference or may be changed from the reference to the person in charge. Also, if another symbol is assigned to an input name of a new user, the task tracking system may indicate that the new user is added as the person in charge or the reference of a task. For example, if the user inputs ‘->->+name’ on the work log area 950, a new user corresponding to the name added to ‘->->’ may be added as a person in charge or a reference.

FIG, 12 illustrates an example of conducting a search using a search box at a task tracking system according to at least one exemplary embodiment.

The task tracking system may provide a search box 1210 for inputting a keyword associated with a project or a task to a message communication tool. In response to an input of the keyword into the search box 1210, the task tracking system may display a search result associated with the keyword.

The task tracking system may provide a search result that is matched to the input keyword and information of a database. The task tracking system may classify information associated with the keyword based on a group, a page, a place, and the like, and may provide the classified information using an index area 1220, and may provide an interface for viewing an additional search result in addition to the search result of the keyword. In response to a user selection on the interface for viewing the additional search result, the user may receive various search results retrieved in various perspectives. For example, if the user selects an interface ‘more view for search results of keyword’, the additional search result associated with the input keyword may be further displayed.

Also, if the user conducts a search without inputting a keyword into the search box 1210, the task tracking system may provide an alert for inducing the user to input the keyword. For example, a message ‘please enter a keyword’ may be popped up. The task tracking system may provide an interface for selecting a search option in the search box 1210. For example, the search option may indicate a selection of a sender, a receiver, etc, before inputting a keyword. The task tracking system may provide, as a search result, a result value that matches the keyword input to the message communication tool and information stored in the database. If no search result is found about the keyword input to the search box 1210, the task tracking system may display information indicating that no search result is found using a message.

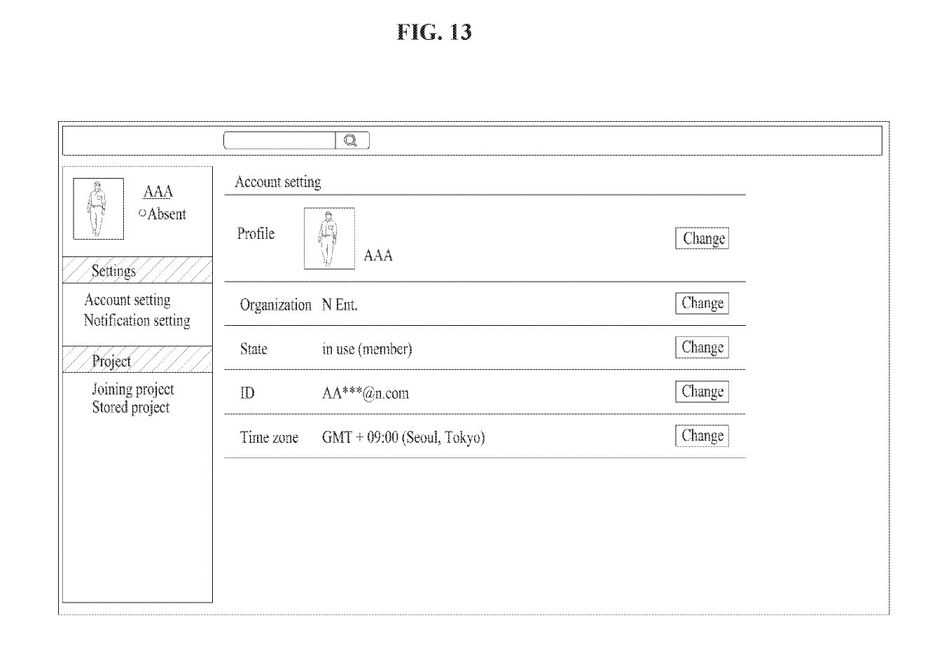

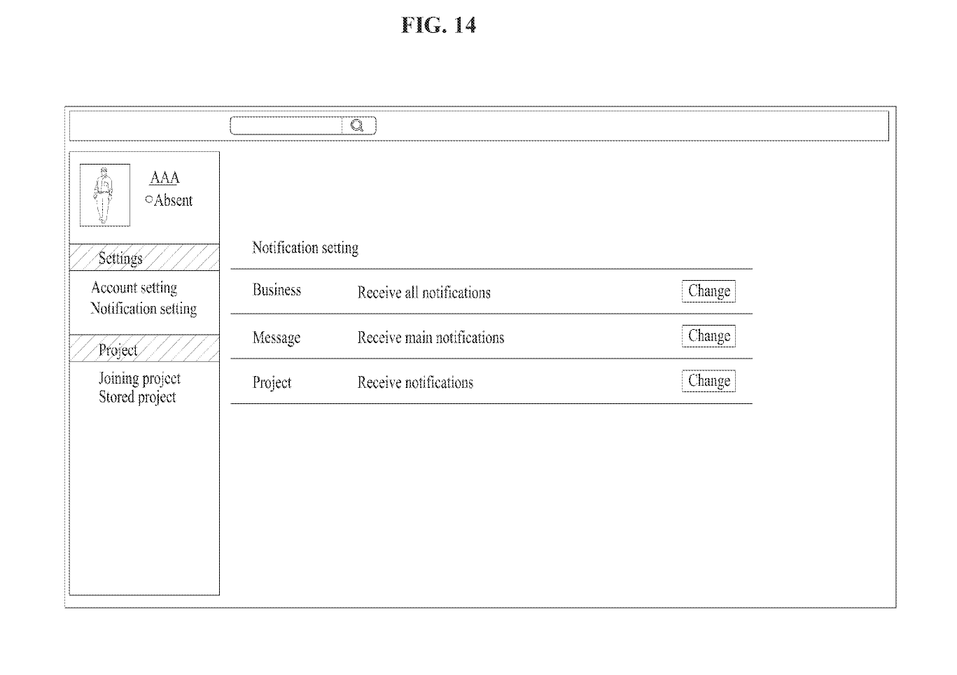

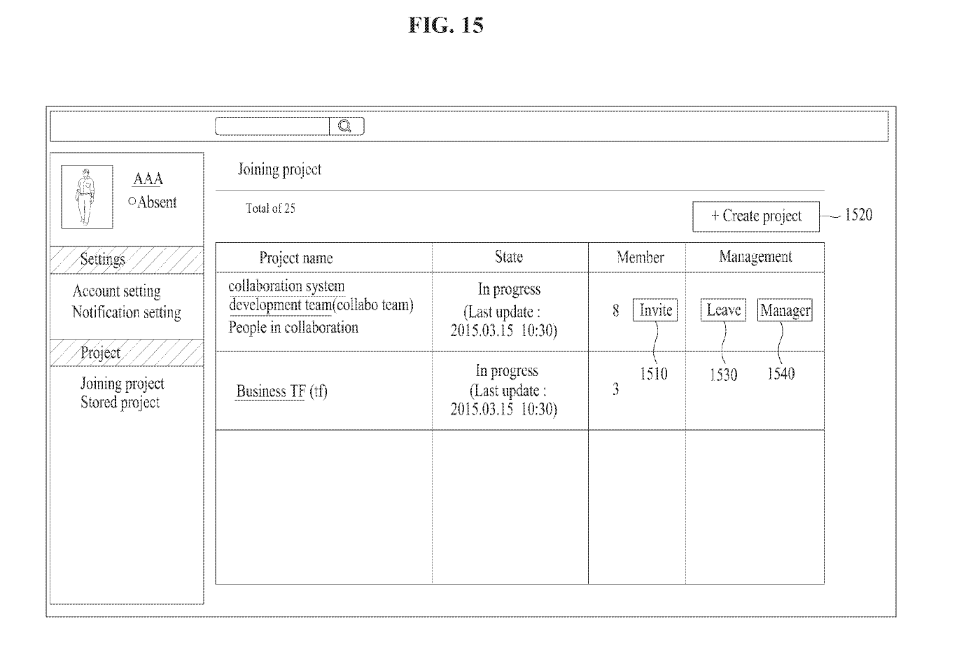

FIGS. 13 through 15 illustrate examples of setting account information at a task tracking system according to at least one exemplary embodiment.

The task tracking system may provide an interface for setting account information through a message communication tool, and may set account information in response to an input of the account information through the interface. For example, referring to FIG. 13, the tracking system may provide an interface for setting profile information, organization information, state information, identification information, time information, etc, in association with an account. In detail, the user may set a profile photo, a name, etc., through the message communication tool, and may set whether to leave the account based on state information indicating a presence/absence of use. Also, the user may set identification information that includes a password, an e-mail, etc., through the message communication tool, and may set time information about a time zone at a user location. The task tracking system may provide an interface for controlling a project management and an organization management through the message communication tool.

Referring to FIG. 14, the task tracking system may provide an interface for setting a notification regarding a task associated with a project through a message communication tool. For example, the task tracking system may provide an interface for setting a notification regarding a project, a task, a message, a business, and the like. The task tracking system may provide an interface for setting notification reception information regarding each of a project associated with a task, a message, and a business. If notification information is input through the interface, a corresponding notification may be set.

Referring to FIG. 15, the task tracking system may display a list of projects or tasks based on an account through a message communication tool, may provide an interface, for example, interfaces 1510, 1520, 1530, and 1540, for setting state information of a task, project information that includes member information and management information, etc. In response to an input of project information through the interface, the project information may be set. For example, the task tracking system may provide an interface for selecting a member to invite in response to a selection on a task associated with a project, and may transmit an invitation e-mail in response to an input of the member through the interface. Further, the task tracking system may manage a member who joins the project or may create the project through the interface.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also, may be distributed over network coupled computer systems so that the software is stored and executed in a distributed fashion. In particular, the software a d data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

The foregoing description has been provided for purposes of illustration and description. It is not intended to be exhaustive or to limit the disclosure. Individual elements or features of a particular exemplary embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A task tracking method comprising:
identifying a message that includes project information associated with a project and complete date information of the project or task associated with the project through a message communication tool;
recognizing the identified message as the task to be tracked based on the project information and the complete date information; and
tracking the task based on a state of the recognized task, classifying the task, and displaying the task through the message communication tool.

2. The method of claim 1, wherein the identifying of the message comprises providing a task layer for inputting the project information and the complete date information, and creating the message in response to an input from a user on at least one of a title, a person in charge, a reference, a description, and a complete date of the project or the task through the task layer.

3. The method of claim 2, wherein the identifying of the message comprises providing an interface for designating a write form of the task layer and inputting at least one of an equation and an image associated with the project or the task.

4. The method of claim 2, wherein the identifying of the message comprises providing a template for designating a main text, a reference, a person in charge, a title, and a date associated with the project or the task on the task layer.

5. The method of claim 2, wherein the identifying of the message comprises switching a text document associated with the project or the task to a specific document by structuring the text document to be in a desired format and by coordinating an arrangement of the text document.

6. The method of claim 1, wherein the tracking, the classifying, and the displaying comprises indicating that a user is designated as a reference or a person in charge of the task and joins the task in response to a tag being assigned to an input name of the user.

7. The method of claim 1, wherein the tracking, the classifying, and the displaying comprises indicating a change from a reference to a person in charge or a change from the person in charge to the reference in response to a symbol being assigned to an input name of the person in charge or the reference of the project or the task, and indicating an addition of a new user as the person in charge or the reference of the task in response to another symbol being assigned to an input name of the new user.

8. The method of claim 1, wherein the tracking, the classifying, and the displaying comprises classifying the task into one of an in-progress state, a standby state, and a complete state.

9. The method of claim 1, wherein the tracking, the classifying, and the displaying comprises classifying the recognized task based on a receiving box that stores a received message as a task, a sending box that stores a sent message as a task, an outbox that stores a temporary message as a task, and a project box.

10. The method of claim 8, wherein the tracking, the classifying, and the display comprises sorting tasks based on a time at which the message is received, a time at which the project or the recognized task is completed, or a time at which the project or the recognized task is updated.

11. The method of claim 1, wherein the tracking, the classifying, and the displaying comprises classifying a member using the message communication tool based on a level, and granting a different right to read the task to the classified member.

12. The method of claim 11, wherein the tracking, the classifying, and the displaying comprises providing an interface for modifying a description of the task to the member granted with the right to read the task.

13. The method of claim 1, wherein the tracking, the classifying, and the displaying comprises displaying a plurality of members that joins the task in association with the task and displaying a progress state of the task for each of the plurality of members.

14. The method of claim 1, herein the tracking, the classifying, and the displaying comprises displaying an importance of the task.

15. The method of claim 1, wherein the tracking, the classifying, and the displaying comprises displaying a task description corresponding to a selected task in response to a selection on at least one task from among tasks displayed through the message communication tool, and
the task description corresponding to the selected task comprises a sender, a participant, a main text, an attachment file, a work log and/a lower work of the selected task.

16. The method of claim 1, wherein the tracking, the classifying, and the displaying comprises displaying a lower task associated with the task with respect to the task.

17. The method of claim 1, wherein the tracking, the classifying, and the displaying comprises, in response to a specific task moving from a different project, automatically numbering the moved specific task using a number associated with the different project and maintaining a link to the project or the different project at the specific task.

18. The method of claim 1, wherein the tracking, the classifying, and the displaying comprises providing a search box for inputting a keyword associated with the task and displaying a search result associated with the keyword in response to an input of the keyword into the search box.

19. A non-transitory computer-readable medium storing computer-readable instructions to cause a computer system to perform a task tracking method, wherein the task tracking method comprises:
identifying a message that includes project information associated with a project and complete date information of the project or a task associated with the project through a message communication tool;
recognizing the identified message as the task based on the project information and the complete date information; and
tracking the task based on a state of the recognized task, classifying the task, and displaying the task through the message communication tool.

20. A task tracking system comprising:
a display; and
a processor configured with executable instructions to provide an identifier and a recognizer and drive the display, wherein
the identifier is configured to identify a message that includes project information associated with a project and complete date information of the project or a task associated with the project through a message communication tool,
the recognizer is configured to recognize the identified message as the task based on the project information and the complete date information, and
the display is configured to track the task based on a state of the recognized task, classifying the task, and to display the task through the message communication tool.
